(19) United States
(12) Patent Application Publication
(10) Pub. No.: US 2007/0205887 A1
(43) Pub. Date: Sep. 6, 2007

(54) Initiative alarm system

(76) Inventor: Ming-Pao Cho, Kaohsiung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/445,245

(22) Filed: Jun. 2, 2006

(30) Foreign Application Priority Data
Mar. 5, 2006 (TW) 095207578

(51) Int. Cl. G08B 1/08; G08B 23/00

(52) U.S. Cl. 340/539.15; 340/539.21; 340/573.4

(57) ABSTRACT

An initiative alarm system mainly comprising a first alarm device and a second alarm device; said first alarm device continuously or alternately transmitted an encoded signal within a certain frequency. In the other hand, said second alarm device includes a receiver for receiving the signal, a CPU for decoding the signal and determining the correctness of received signal, and a siren interconnected with CPU and trigged when the signal is fail to be received or fail to be received within certain frequency. Said second alarm device is hand-hold by a guardian and said first alarm device is carried by a protective object so as when the first alarm device is kept away beyond the certain distance. The signals will be transmitted immediately, and then, the siren is simultaneously triggered.

### BACKGROUND OF THE INVENTION

1. Field of the Invention

The present invention relates to an alarm system, in particularly to an initiative alarm system.

2. Description of the Related Art

Referring to FIG. 1, a conventional alarm system 1 is relative to a passive alarm system and comprises a first alarm device 11 and a second alarm device 12; said first alarm device 11 includes a battery power supply 111, a receiver 113, a siren 114 connecting and be acted with receiver 113 and a transmitter 112 having a button 112a for controlling the transmitter 112; said second alarm device 12 also has a battery power supply 121, a receiver 123, a siren 124 connecting and be acted with receiver 123 and a transmitter 122 having a button 112a for controlling the transmitter 122.

During the operation, said first alarm device or said second alarm device selectively held by a guardian and a kid. When the kid losses the contact with the guardian, he can press on the button to transmit the signals to the alarm device so as to alert the guardian's situation. Said guardian can try to figure out the direction of kid by continuously pressing on the button so to trigger the siren on the alarm device by each of them.

In use, the conventional method for installing the stool has several defects.

1. Said first alarm device or second alarm device should be triggered only when guardian or kid aware of the missing of each other. Therefore, said first alarm device or second alarm device have to use by people, and each of them only be triggered in limited distance.

2. Said first alarm device and second alarm device have to be interacted within a certain distance. If the guardian and kid are both unconscious of the losing, they might move beyond the distance in which alarm devices can reach.

### SUMMARY OF THE INVENTION

Therefore, the object of present invention is to provide a initiative alarm system, which includes a first alarm device and second alarm device which is facilitate to warn the holders effectively and initiatively that is capable of overcoming the aforesaid drawback of the prior art.

The present invention relates to an initiative alarm device that comprises a first alarm device and a second alarm device; said first alarm device includes a signal-encoding unit generating an encoded signal, and a radio-frequency (RF) signal carrier for regulating the frequency of signal and radiating the RF signal. Said second alarm device includes a receiver for receiving the RF signal, a CPU for decoding the signal and determining the correctness of the signal, and a siren interconnecting and interacting with the CPU. By the means of signal detecting, said second alarm device is capable of triggering the siren when the signal is fail to be received within a certain frequency or an incorrect signal is received.

The present invention will become more obvious from the following description when taken in connection with the accompanying drawings which show, for purposes of illustration only, a preferred embodiment in accordance with the present invention.

### BRIEF DESCRIPTION OF THE DRAWINGS

The accompanying drawings futures are included to provide a further understanding of the invention, and are incorporated in and constitute a part of this specification. The drawings illustrate an embodiment of the invention and, together with the description, to explain the principles of the invention. In the drawing,

FIG. 1 is a block diagram showing a conventional alarm system;

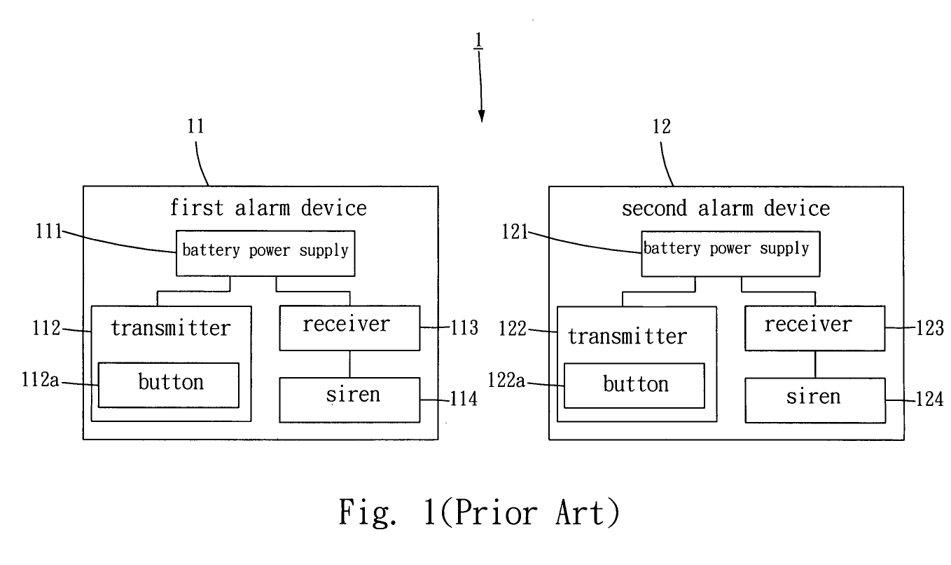

FIG. 2 is a block diagram showing the first embodiment of present invention according to an initiative alarm system;

FIG. 3a is a circuit showing the first embodiment of present invention according to an initiative alarm system; and

FIG. 3b is a circuit showing the first embodiment of present invention according to an initiative alarm system.

FIG. 4 is a block diagram showing the second embodiment of present invention according to an initiative alarm system.

### DETAILED DESCRIPTION OF THE PREFERRED EMBODIMENTS

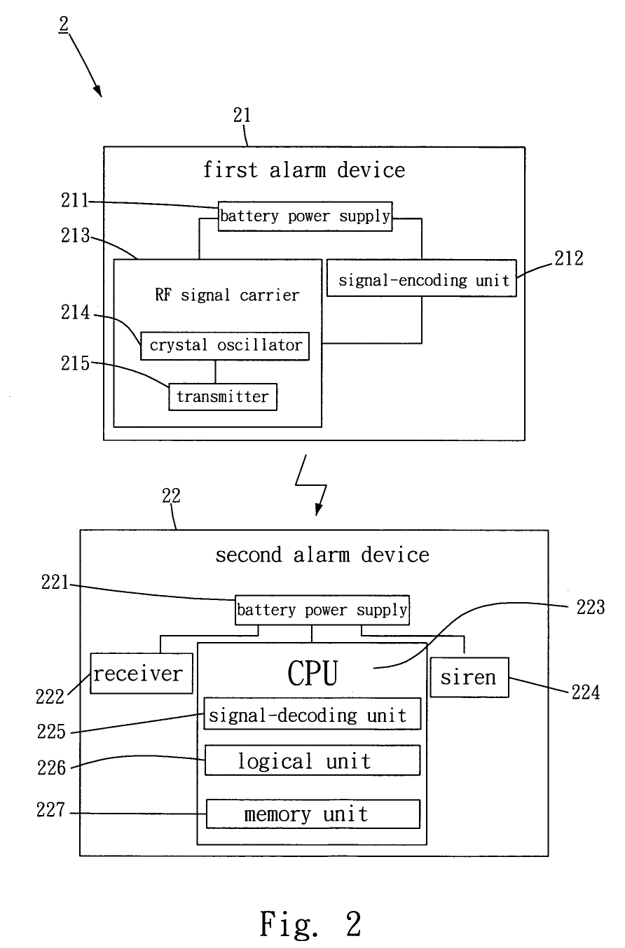

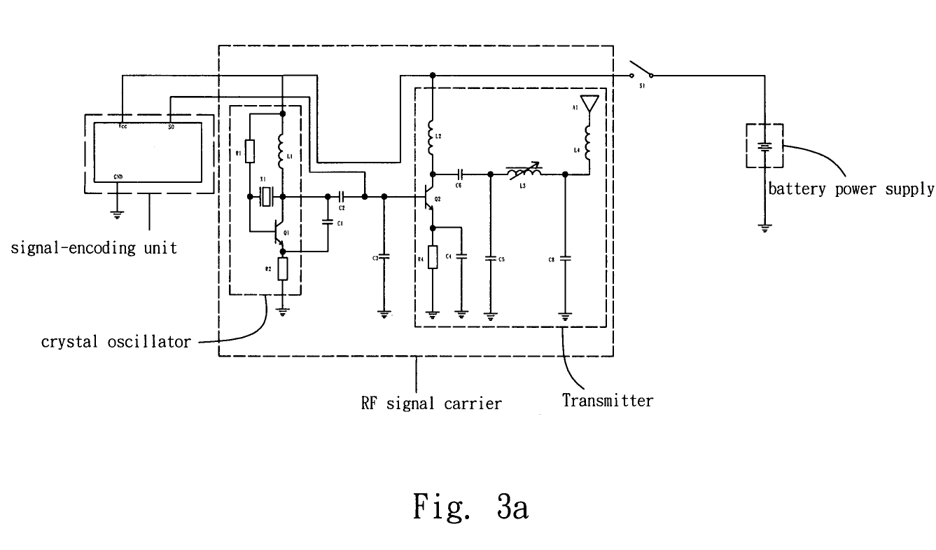

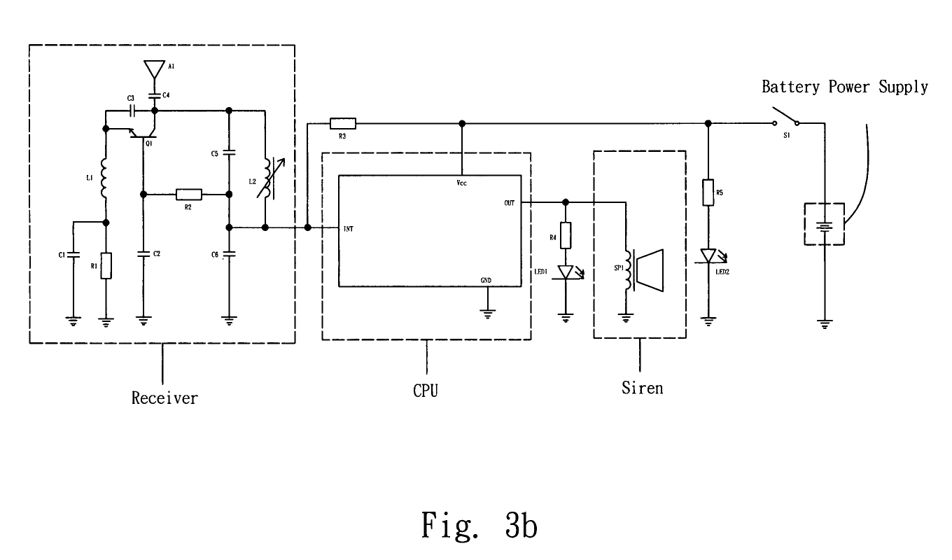

Referring to FIGS. 2, 3a and 3b, the first embodiment of the present invention according to an initiative alarm system 2 comprises a first alarm device 21 and a second alarm device 22; said first alarm device 21 includes a signal-encoding unit 212, a radio frequency (RF) signal carrier 213 in communication with the signal-encoding unit 212 and a battery power supply 211 providing power to the signal-encoding unit 212 and the RF signal carrier 213. The signal-encoding unit 212 functions of generating an addressed signal and encoding the signal; Said addressed signal is setup in the signal encoding unit 212 beforehand that is capable of being recognized by second alarm device. The radio frequency (RF) signal carrier 213 further has a crystal oscillator 214 that is capable of regulating the frequency of signals and a transmitter 215 continuously radiating the RF signal. A second alarm device 22 including a receiver 222 for receiving the RF signal from the first alarm device, a central processing unit(CPU) 223 in communication with the receiver 222, a siren 224 interconnecting to the CPU 223 and a batter power supply 221 providing power to the receiver 222, the CPU 223 and the siren 224; Said central processing unit(CPU) 223 further has a signal-decoding unit 223a for decoding the input signal, a logical unit 223b for detecting a confirmation signal at a certain radio frequency, and a memory unit 223c connecting with the logical unit 223b for providing a compared signal; said siren 224 interacted with CPU 223 and triggered by logical unit 223b when the signal is fail to received within certain frequency or an incorrect signal is received;

During the operation, said second alarm device 22 is held by a user or protector and the first alarm device 21 is carried by the protective person or installed on the protective objects like a purse, a briefcase or a notebook that is usually hand-held by the user. When the power of first alarm device 21 turns on, said signal-encoding unit 212 continuously generates an addressed signal and encodes the addressed signal outputting to RF signal carrier 213. The signal is regulated to a certain frequency (2 RF signals per second) via crystal oscillator 214 in RF signal carrier 213 and amplified to radiate outward by the transmitter 215. Meanwhile by turning on the power of second alarm device 22, the receiver 222 begins receiving the signals and outputs the signal to the CPU 223. Said received signal is decoded by signal-decoding unit 223a, and further confirmed and recognized by logical unit 223b in the CPU 223. Said logical unit 223b compared the received signal to the signal save in the memory unit 223c. If the signal is normally and correctly received, the siren will stay mute. However, once the signals are fail to be received or received without certain frequency, the logical unit 223b will trigger the siren 224 to give off sound. As a consequence, when the protective object is miss or taken away (stolen) to a certain distance in which signals are unable to reach, said siren 224 will be triggered to warn the users or protectors.

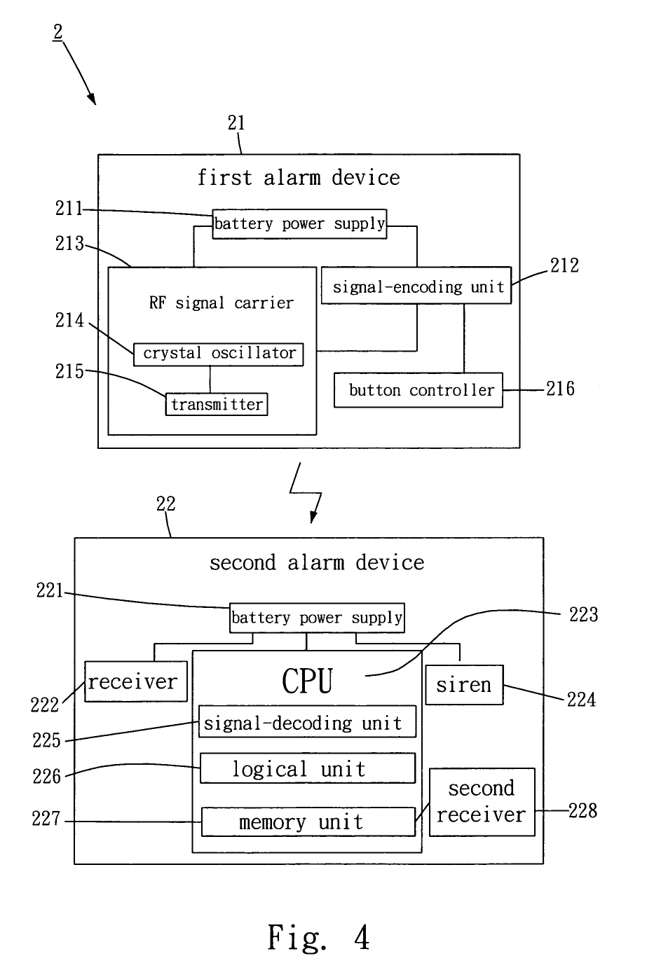

Referring to FIG. 4, the second embodiment of present invention according to an initiative alarm system, wherein said memory unit 223c is further connected with a second receiver 225 that is capable of receiving the signals from an unfamiliar first alarm device desired to search inductor with the second alarm device 22 and storing the signals in the memory unit 223c for comparing. Besides, said signal-encoding unit 212 is further connected with a button controller 212a for controlling the generating of signals so as to prevent the battery power from running out in short time.

To sum up with above description, the present invention provides the following advantages:
1. By the means of signals encoding and decoding unit, said second alarm device can avoid receiving the stranger signals.
2. The second alarm device is able to stay mute by constantly receiving the signals from first alarm device. Once the first alarm device is taken away to a certain distance, users will be immediately notified by the warning of siren.
3. When the battery power turns on, said first alarm device and second alarm device are automatically activated so as that the users need not to do further operation.

While we have shown and described the embodiment in accordance with the present invention, it should be clear to those skilled in the art that further embodiments may be made without departing from the scope of the present invention.

I claim:

1. An initiative alarm system comprising:
A first alarm device including:
a signal-encoding unit for generating an addressed signal and encoding the signal;
a radio frequency (RF) signal carrier, in communication with said signal-encoding unit, having an crystal oscillator that is capable of regulating the signal to a certain frequency and a transmitter continuously radiating the RF signal;
a battery power supply provides power to the signal-encoding unit and the RF signal carrier.
A second alarm device including:
a receiver for receiving the RF signal from the first alarm device;
a central processing unit (CPU) including signal-decoding unit for decoding the input signal, logical unit for detecting a confirmation signal at a certain radio frequency, and a memory unit connecting with the logical unit for providing a compared signal;
a siren connected with CPU and triggered when the certain radio frequency is fail to received; and
a battery power supply providing power to the receiver, the CPU and the siren.

2. The initiative alarm system as claimed in claim 1, wherein said memory unit is connected with a second receiver for receiving the signals from an unfamiliar first alarm device desired to make pairing with the second alarm device and storing the signals in the memory unit for comparing.

3. The initiative alarm system as claimed in claim 1, wherein signal-encoding unit further connected with a button controller for controlling generating of the signals.
